(19) United States
(12) Patent Application Publication
(10) Pub. No.: US 2021/0312084 A1
(43) Pub. Date: Oct. 7, 2021

(54) SYSTEMS AND METHODS FOR MANAGING DIGITAL MEDIA ITEMS ACCESS

(71) Applicant: Rovi Guides, Inc., San Jose, CA (US)

(72) Inventor: Yusuf AbdElhakam AbdElkader Marey, Tulsa, OK (US)

(21) Appl. No.: 16/837,366

(22) Filed: Apr. 1, 2020

(51) Int. Cl. G06F 21/62; G06T 5/00; G06K 9/00; G06F 21/10; G06F 21/32

(52) U.S. Cl. CPC G06F 21/6254; G06T 5/002; G06K 9/00288; G06F 2221/0715; G06F 21/32; G06T 2207/20132; G06F 21/10

(57) ABSTRACT

A server causes a social media application to be implemented on a client device. The social media application is configured to receive a request from a first user to restrict a plurality of users from identifying the first user in the digital media. The social media application requests the server to scan a plurality of digital media items uploaded to the server to identify a set of digital media items featuring the first user. The server identifies a set of digital media items related to the first user and modifies a portion of the identified set of digital media items to obfuscate the identity of the first user prior to transmitting the identified set of digital media items to a plurality of client devices having the social media application installed thereon.

### BACKGROUND

The present disclosure relates to managing access to digital media items uploaded on one or more social media platforms and, more particularly, to restricting a plurality of users from identifying a user in digital media items uploaded on one or more social media platforms featuring the user.

### SUMMARY

Systems and methods are described herein for managing access to digital media. Countless numbers of applications allow users to upload digital media items such as videos and photographs online for public consumption. Such applications include services such as FACEBOOK, TWITTER, INSTAGRAM, WHATSAPP, SNAPCHAT, etc. A user might not want images of themselves to be available for public consumption for a number of reasons. In some instances, the user might want a specific person to be restricted from viewing photographs featuring them. Conventionally, social media platforms provide the ability to restrict certain users from viewing digital media items uploaded by the first user by putting them on a “blocked” list. However, the restricted people may still view digital media items featuring the first user when uploaded by other users. For example, a mutual friend may upload one or more photographs featuring the first user on one or more social media platforms where the plurality of users on the first user's “blocked” list can still view those photographs. Currently, if a user wishes to have someone restricted from viewing digital media items featuring them altogether, their only option is to request the person uploading the digital media items to take it down from the social media platform. However, the person uploading the digital media items featuring the user may not wish to take down the digital media items for any number of reasons.

Accordingly, a solution and improvement are needed for media access systems to allow a user to control who can view digital media items featuring them that has been uploaded on one or more social media platforms. In one embodiment, the user can send a request to a server to restrict a plurality of users from identifying the first user in digital media items uploaded to the server, where the plurality of users have access to digital media items uploaded to the server. In one embodiment, the plurality of digital media items can be uploaded to the server via a social media application, implemented on a respective client device, associated with the plurality of users. For example, any number of users may upload photographs on a server associated with the FACEBOOK application from their respective smartphones.

The server, in response to receiving the request, scans a plurality of digital media items uploaded to the server to identify a set of digital media items related to the first user. In some embodiments, the server may use one or more know facial recognition software to scan the digital media items uploaded to the server. The server identifies one or more digital media items from the set of digital media items uploaded to the server which feature the first user. For example, the server may identify a set of photographs in which the first user is present.

Once the server identifies the set of digital media items featuring the first user, the server restricts the plurality of users from identifying the first user in the identified set of digital media items featuring the first user. For example, in an embodiment, the server blurs a portion of the digital media items featuring the first user to obscure the identity of the first user. The server then presents the blurred digital media items to the plurality of users. Alternatively, the server may crop a portion of the digital media items that features the first user before presenting the digital media items to the plurality of users. In this way, systems and methods discussed here can restrict the plurality of users from identifying the first user in the identified set of digital media items featuring the user.

In some embodiments, the first user can also specify a geolocation such that a plurality of users are restricted from identifying the first user in digital media items captured at the specified geolocation that features the first user. For example, the first user may wish to avoid having any images of them at their home be publicly available for privacy concerns. In such an instance, the server may identify one or more digital media items featuring the first user which were photos taken at or around the first user's home and blur a portion of the identified set of digital media items featuring the first user.

In some embodiments, the first user can also specify a duration of time such that a plurality of users are restricted from identifying the first user in digital media items captured during the duration of time that feature the first user. For example, the first user may wish to avoid having any images of them taken during a family vacation be available for viewing by their work colleagues. In such an instance, the server may identify one or more digital media items featuring the first user that were taken during the vacation and blur a portion of the identified set of digital media items featuring the first user. Accordingly, systems and methods implementing the subject matter of this disclosure are able to manage access to digital media items uploaded on one or more social media platforms and, more particularly, restrict a plurality of users from identifying a user in digital media items uploaded on one or more social media platforms featuring the user.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of system display, in accordance with one embodiment;

FIG. 2 shows another illustrative example of system display, in accordance with one embodiment;

FIG. 3 depicts an illustrative flowchart of a process for restricting a plurality of users from identifying a user in digital media items uploaded on a social media platform, in accordance with one embodiment;

FIG. 4 is a block diagram of an illustrative electronic device having a social media application installed thereon, in accordance with one embodiment;

FIG. 5 is a block diagram of an illustrative device, in accordance with one embodiment;

FIG. 6 depicts an illustrative flowchart of a process for restricting a plurality of users from identifying a user in digital media items captured at a specified geolocation, in accordance with one embodiment; and

FIG. 7 depicts an illustrative flowchart of a process for restricting a plurality of users from identifying a user in digital media items uploaded during a duration of time, in accordance with one embodiment.

### DETAILED DESCRIPTION

Methods and systems are described herein for restricting a plurality of users from identifying a user in digital media items uploaded on a social media platform by modifying the digital media items to obscure the identity of the user.

For example, users may upload any number of digital media items to a server which then makes the digital media items available for access by a plurality of users. As discussed below in greater detail, in one example, the plurality of users are able to view uploaded digital media items via one or more applications installed on their respective electronic devices such as a computer, smartphone, etc. In another example, the uploaded digital media items might be hosted on a file sharing website, social networking website, image hosting website, or other software application. The plurality of users can be provided with an interface whereupon they are able to view the uploaded digital media. As used herein, the term “user” includes an owner and/or operator of a profile or account on the social media application or the website where the uploaded digital media items is made accessible (e.g., FACEBOOK, TWITTER, INSTAGRAM, WHATSAPP, SNAPCHAT, etc.). The term “digital media” includes all media content that is in digital form or that it is possible to convert to digital form—including but not limited to images (photographic, GIFs, or otherwise), video in the form of digital video, motion pictures, television shows (as serves, as seasons, and as individual episodes), books (fiction and non-fiction), magazines, newspapers, scientific papers, articles, or other periodicals, and other interactive media.

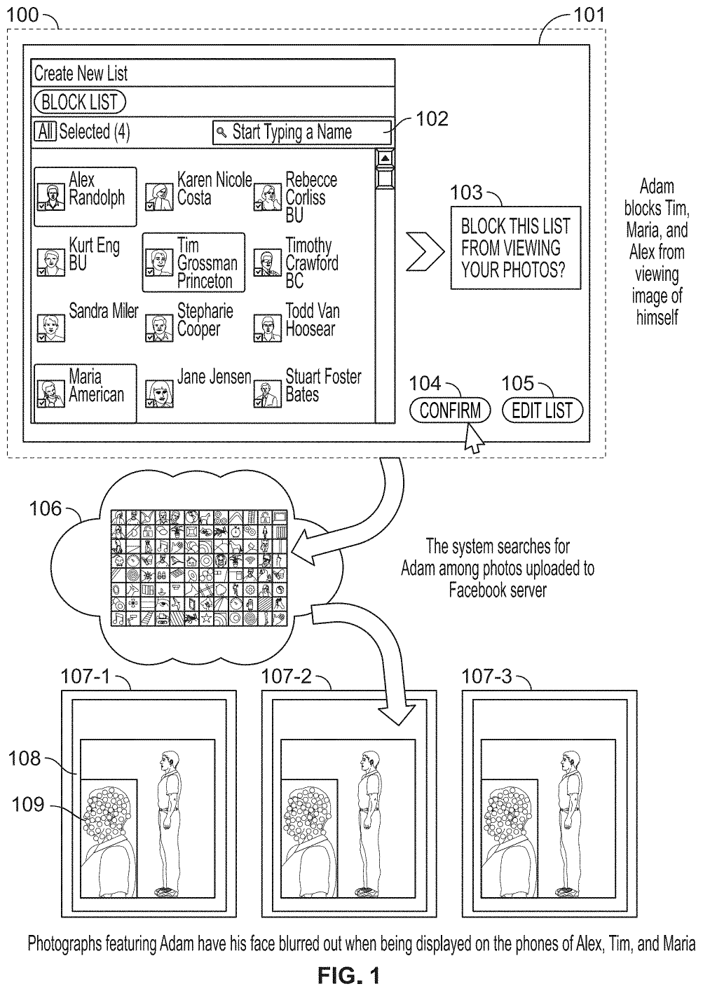

FIG. 1 shows an illustrative display screen 101 on a user device 100 that may be used by a first user to restrict a plurality of users from being able to identify the first user in digital media items uploaded on a server. Some examples of user device 100 includes a mobile device, a personal laptop, or tablet computer, a television, etc. The display screen may be implemented on any suitable user equipment device or platform. The display may be a full screen display or may also be fully or partially overlaid over content being displayed. A user may indicate a desire to view content information (such as a list of users who have access to a particular social media application) by selecting a selectable option (not shown) provided in a display screen (e.g., a menu option, a listings option, an icon, a hyperlink, etc.) or another user interface or device. In response to the user's indication, a server (e.g., a cloud server that communicates with a social media application installed on the respective user devices) may provide the display screen with a list of users 102 who have access to digital media items uploaded to the server. The first user can then select a plurality of users (e.g., select Tim, Maria, and Alex to be on a “block” list) using the selectable options on the display 101. The display 101 may additionally present selectable options 103 asking for the first user to order the “block” list along with selectable options 104 (option to confirm) and 105 (option to go back and edit the “block” list). Selectable options 103, 104, and 105 are optional and that any number of selectable options may be displayed.

As discussed, the first user selects a plurality of users (e.g., Tim, Maria, and Alex) from the list 102 and requests that they be blocked from viewing digital media items featuring the first user. The request is transmitted to server 106 which maintains a database of digital media items that have been previously uploaded. Server 106 scans each of the uploaded digital media items using one or more known facial recognition software to identify a plurality of digital media items featuring the first user. For instance, server 106 may use AMAZON REKOGNITION to scan photographs uploaded to the server to identify a plurality of images that feature the first user. Although the description above states that every digital media item file uploaded to server 106 is scanned to identify digital media items featuring the first user, the system can narrow down the number of digital media items files that require scanning by the facial recognition software to increase computational efficiency. For example, server 106 may narrow down the pool of digital media items to be scanned by the facial recognition software by relying on geolocation information and time-of-capture information. In one example, if the first user has been in New York City for the past year without traveling, server 106 may eliminate all digital media items captured at locations outside New York City from the pool of digital images scanned by the facial recognition software.

Once server 106 identifies the digital media items featuring the first user, server 106 modifies the identified set of digital media items to obfuscate the identity of the first user. For example, server 106 may blur a portion of the photographs featuring the first user to obscure their identity. As illustrated in FIG. 1, when the plurality of users on the “blocked” list access the digital media items uploaded on server 106, server 106 presents a modified digital media items 108 on their respective devices 107-1, 107-2, and 107-3 (collectively 107) which includes a blurred portion 109. For example, when Tim, Maria, and Alex view the images uploaded by other users on server 106, the images are blurred to obscure the identity of the first user. Accordingly, the plurality of users associated with electronic devices 107 are restricted from viewing images of the first user.

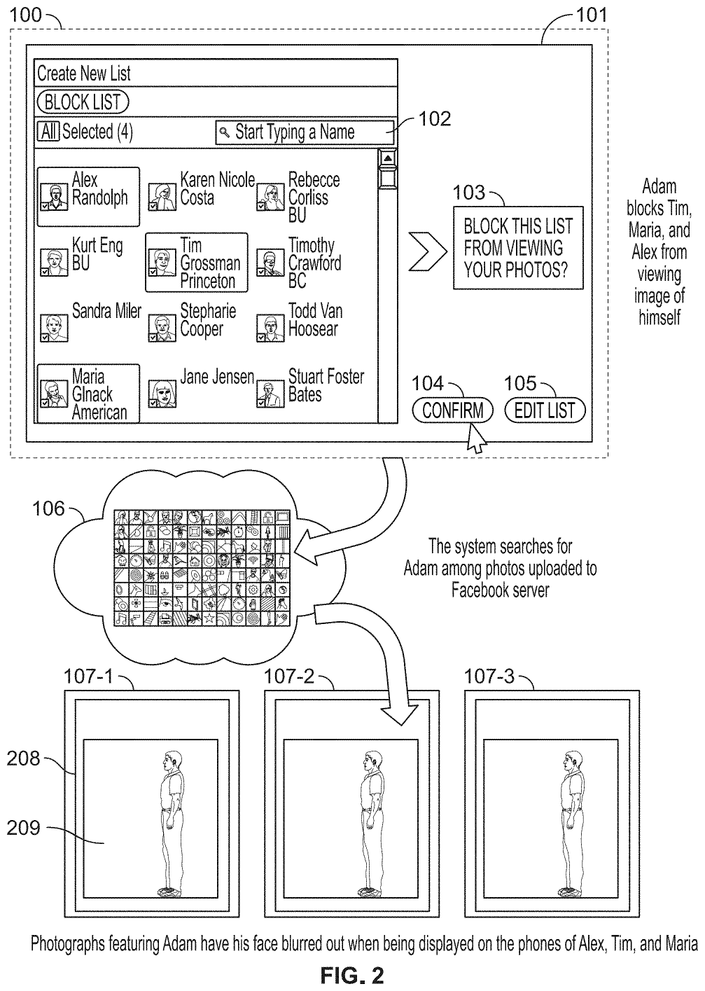

FIG. 2 shows another illustrative example of system display in accordance with some embodiments of the disclosure. As discussed above with reference to FIG. 1, a first user (e.g., Adam) can select a list of people (e.g., Tim, Maria, and Alex) who are to be restricted from viewing digital media items (e.g., photographs, videos, etc.) featuring Adam. Server 106, in response to receiving the request from Adam, scans the library of digital media items previously uploaded and identifies a set of digital media items featuring him. As further illustrated in FIG. 2, in order to obscure the identity of the first user, server 106 crops a portion 209 of digital media items 208—instead of merely blurring the portion—prior to transmitting the digital media items to the respective electronic devices 107 associated with the plurality of users. Accordingly, the plurality of users associated with electronic devices 107 are restricted from viewing images of the first user. The methods shown in FIGS. 1 and 2 for obscuring the identity of the first user are provided merely for example purposes only and any number of techniques for obscuring the identity of the first user may be used. For example, in one embodiment, the portion of the digital media items featuring the first user may be covered by a black bar to obscure the identity of the first user.

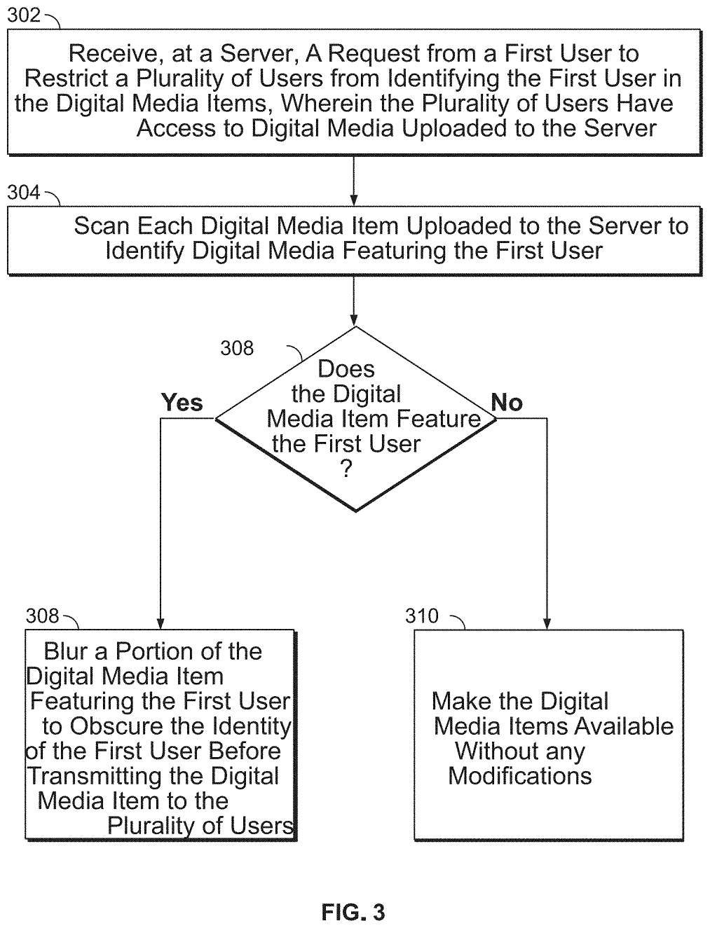

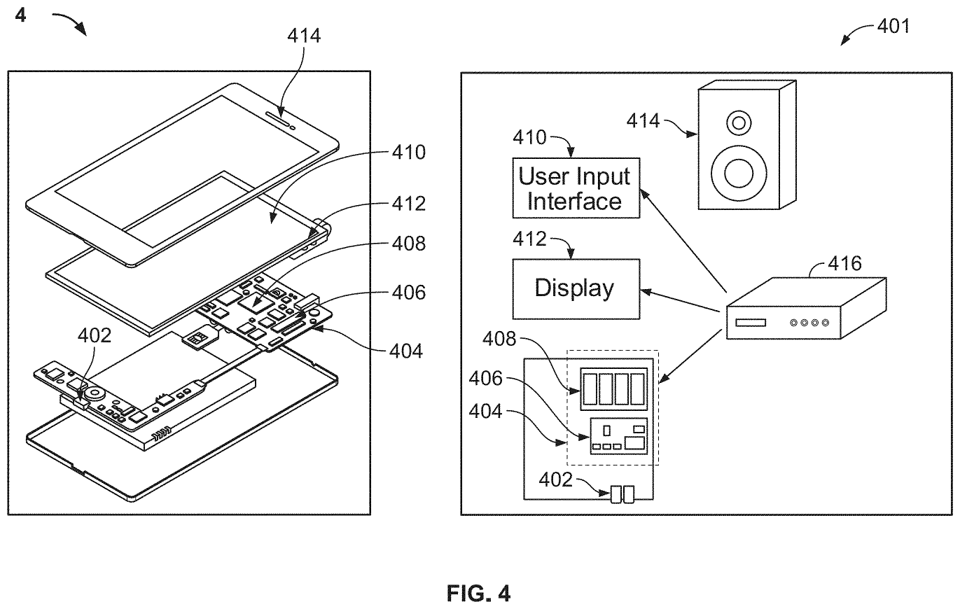

FIG. 3 depicts an illustrative flowchart of a process for restricting a plurality of users from identifying a user in digital media items uploaded on a social media platform, in accordance with some embodiments of the disclosure. The illustrative steps of process 300 may be performed by, for example, device 400 of FIG. 4, or control circuitry 404 thereof.

Step 302 includes control circuitry (e.g., control circuitry 404) receiving a request from a first user to restrict a plurality of users from identifying the first user in the digital media, where the plurality of users have access to digital media items uploaded to the server. For example, a first user may select a list of users who are to be restricted from viewing digital media items featuring the first user.

Step 304 includes control circuitry scanning each digital media item uploaded to the server to identify digital media items featuring the first user. In some embodiments, control circuitry 404 may employ one or more facial recognition software to scan the plurality of digital images in order to identify digital images featuring the first user. For instance, control circuitry 404 may employ commercially available facial recognition software such as AMAZON REKOGNITION or FACEFIRST, etc.

Step 306 includes control circuitry determining whether each of the digital media items feature the first user. For example, control circuitry 404 may use any known facial recognition software to scan each digital media item uploaded to the server to identify a set of digital media items featuring the first user. Specifically, control circuitry 404 uses the results of the facial recognition software at Step 304 to identify a set of images and/or videos that feature the first user uploaded on the server.

If, at step 306, control circuitry determines that the digital media item features the first user (YES at step 306), the process 300 proceeds to Step 308 discussed below. If, on the other hand, at step 306, control circuitry determines that the digital media item does not feature the first user (NO at step 306), process 300 proceeds to Step 310. Step 310 includes control circuitry making the digital media items available without any modification for viewing by the plurality of users.

Step 308 includes control circuitry modifying the digital media items to obscure the identity of the first user. For example, control circuitry 404 may blur a portion of the digital media items featuring the first user to obscure the identity of the first user before transmitting the digital media items to the social media application where they can be accessed by the plurality of users. In another embodiment, control circuitry 404 may crop the portion of the digital media items featuring the first user before transmitting the digital media items to the social media application where they can be accessed by the plurality of users. In this way, process 300 prevents the plurality of users from viewing digital media items featuring the first user.

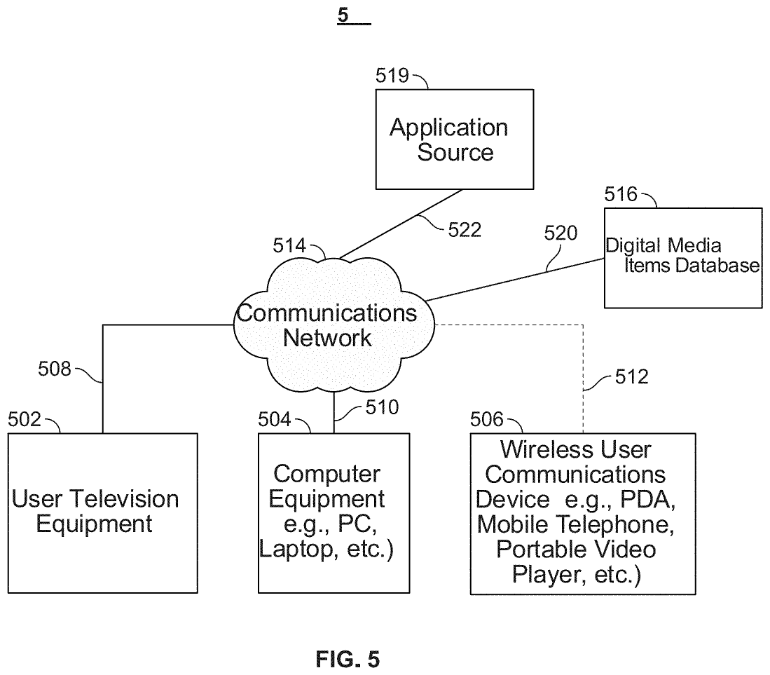

Users may access digital media items uploaded by other users via one or more of their devices. FIG. 4 shows generalized embodiments of a device capable of presenting content on a display 412. For example, display 412 may belong to a smartphone or computing device. In another example, display 412 may belong to a user television equipment system. A computing device with display 412 may include a set-top box 416. Set-top box 416 may be communicatively connected to speaker 414 and display 412. In some embodiments, display 412 may be a television display or a computer display. In some embodiments, set top box 416 may be communicatively connected to user interface input 410. In some embodiments, user interface input 410 may be a remote-control device. Set-top box 416 may include one or more circuit boards. In some embodiments, the circuit boards may include processing circuitry, control circuitry, and storage (e.g., RAM, ROM, Hard Disk, Removable Disk, etc.). Such storage can include computer readable media, computer program products, etc. to store digital media items and social media applications including instructions to implement the techniques described herein. In some embodiments, circuit boards may include an input/output path. More specific implementations of devices are discussed below in connection with FIG. 5. Each one of device 400 and user equipment system 401 may receive content and data via input/output (hereinafter “I/O”) path 402. I/O path 402 may provide content (e.g., broadcast programming, on-demand programming, Internet content, content available over a local area network (LAN) or wide area network (WAN), and/or other content) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths but are shown as a single path in FIG. 4 to avoid overcomplicating the drawing.

Control circuitry 404 may be based on any suitable processing circuitry such as processing circuitry 406. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for an application such as an image sharing (e.g. social media platform) application stored in memory (e.g., storage 408). Specifically, control circuitry 404 may be instructed by the application to perform the functions discussed above and below. For example, the application may provide instructions to control circuitry 404 to identify a set of digital media items featuring the user. In some implementations, any action performed by control circuitry 404 may be based on instructions received from the application to perform methods described herein.

In client/server-based embodiments, control circuitry 404 may include communications circuitry suitable for communicating with a content application server or other networks or servers. The instructions for carrying out the above-mentioned functionality may be stored on the content application server. Communications circuitry may include a cable modem, an integrated service digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of devices, or communication of devices in locations remote from each other (described in more detail below).

Memory may be an electronic storage device provided as storage 408 that is part of control circuitry 404. As referred to herein, the phrase “electronic storage device” or “storage device” or “computer readable storage” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein, including, for example, photographs and video files. Storage 408 may also be used to store identifications of each of the users within a social network of the person uploading the digital media items in order to improve the facial recognition capabilities. Nonvolatile memory may also be used (e.g., to launch a boot-up routine and other instructions). Storage 408 may also store rules set by the user for managing access to digital media items uploaded on the server which features said user. Cloud-based storage, described in relation to FIG. 5, may be used to supplement storage 408 or instead of storage 408. In some embodiments, a database is accessible at the cloud-based storage, where the database stores digital media items uploaded to the server along with metadata files associated with the digital media, which may include information such as, for example, the location and time at which the digital media items was captured.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and down-converting content into the preferred output format of the user equipment 400. Circuitry 404 may also include digital-to-analog converter circuitry and analog-to-digital converter circuitry for converting between digital and analog signals. The tuning and encoding circuitry may be used by the device to receive and to display, to play, or to record content. The tuning and encoding circuitry may also be used to receive digital media items uploaded to the server. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may send instructions to control circuitry 404 using user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of each one of device 400 and user equipment system 401. For example, display 412 may be a touchscreen or touch-sensitive display. In such circumstances, user input interface 410 may be integrated with or combined with display 412. Display 412 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 412 may be HDTV-capable. In some embodiments, display 412 may be a 3D display, and the interactive application and any suitable content may be displayed in 3D. A video card or graphics card may generate the output to the display 412. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 404. The video card may be integrated with the control circuitry 404. Speakers 414 may be provided as integrated with other elements of each one of device 400 and user equipment system 401 or may be stand-alone units. The audio component of videos and other content displayed on display 412 may be played through speakers 414. In some embodiments, the audio may be distributed to a receiver (not shown), which processes and outputs the audio via speakers 414.

The social media application may be implemented using any suitable architecture. For example, it may be a stand-alone application wholly implemented on each one of device 400 and user equipment system 401. In such an approach, instructions of the application are stored locally (e.g., in storage 408), and data for use by the application is downloaded on a periodic basis (e.g., from an out-of-band feed, from an Internet resource, or using another suitable approach). Control circuitry 404 may retrieve instructions of the application from storage 408 and process the instructions to generate any of the displays discussed herein. Based on the processed instructions, control circuitry 404 may determine what action to perform when input is received from input interface 410. In some embodiments, the social media application can be downloaded to user equipment (e.g., user equipment system 401) from an application source such as a server or an App Store. In one example, the social media application is pre-configured and downloaded to user equipment to implement the techniques for limiting access to digital media items disclosed herein. In other examples, the social media application is downloaded to the user equipment then updated to implement the disclosed techniques.

In some embodiments, the social media application is a client/server-based application. Data for use by a thick or thin client implemented on each one of device 400 and user equipment system 401 is retrieved on demand by issuing requests to a server remote to each one of device 400 and user equipment system 401. In one example of a client/server-based application, control circuitry 404 runs a web browser that interprets web pages provided by a remote server. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on equipment device 400. This way, the processing of the instructions is performed remotely by the server while the resulting displays are provided locally on equipment device 400.

In some embodiments, the social media application is downloaded and interpreted or otherwise run by an interpreter or virtual machine (run by control circuitry 404). In some embodiments, the social media application may be encoded in the ETV Binary Interchange Format (EBIF), received by control circuitry 404 as part of a suitable feed, and interpreted by a user agent running on control circuitry 404. For example, the social media application may be an EBIF application. In some embodiments, the social media application may be defined by a series of JAVA-based files that are received and run by a local virtual machine or other suitable middleware executed by control circuitry 404. In some of such embodiments (e.g., those employing MPEG-2 or other digital media items encoding schemes), the social media application may be, for example, encoded and transmitted in an MPEG-2 object carousel with the MPEG audio and video packets of a program.

Each one of device 400 and user equipment system 401 of FIG. 4 can be implemented in system 500 of FIG. 5 as user television equipment 502, user computer equipment 504, wireless user communications device 506, or any other type of user equipment suitable for accessing content, such as a non-portable gaming machine. For simplicity, these devices may be referred to herein collectively as user equipment or devices and may be substantially similar to devices described above. Devices on which an application may be implemented may function as stand-alone devices or may be part of a network of devices. Various network configurations of devices may be implemented and are discussed in more detail below.

A device utilizing at least some of the system features described above in connection with FIG. 4 may not be classified solely as user television equipment 502, user computer equipment 504, or a wireless user communications device 506. For example, user television equipment 502 may, like some user computer equipment 504, be Internet-enabled, allowing for access to Internet content, while user computer equipment 504 may, like some television equipment 502, include a tuner allowing for access to television programming. The application may have the same layout on various different types of user equipment or may be tailored to the display capabilities of the user equipment. For example, on user computer equipment 504, a social media application may be provided as a web site accessed by a web browser. In another example, the social media application may be scaled down for wireless user communications devices 506.

In system 500, there is typically more than one of each type of device, but only one of each is shown in FIG. 5 to avoid overcomplicating the drawing. In addition, each user may utilize more than one type of device and also more than one of each type of device.

In some embodiments, a device (e.g., user television equipment 502, user computer equipment 504, wireless user communications device 506) may be referred to as a “second device.” For example, a second device may provide an interface for adjusting settings and display preferences of the first device. In some embodiments, the second device is configured for interacting with other second devices or for interacting with a social network. The second screen device can be located in the same room as the first device, a different room from the first device but in the same house or building, or in a different building from the first device.

The devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 4G or LTE network), cable network, public switched telephone network, or other types of communications network or combinations of communications networks. Paths 508, 510, and 512 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path, and paths 508 and 510 are drawn as solid lines to indicate they are wired paths (although these paths may be wireless paths, if desired). Communications with the devices may be provided by one or more of these communications paths but are shown as a single path in FIG. 5 to avoid overcomplicating the drawing.

Although communications paths are not drawn between devices, these devices may communicate directly with each other via communication paths, such as those described above in connection with paths 508, 510, and 512, as well as other short-range point-to-point communication paths, such as USB cables, IEEE 1394 cables, wireless paths (e.g., Bluetooth, infrared, IEEE 502-11x, etc.), or other short-range communication via wired or wireless paths. BLUETOOTH is a certification mark owned by Bluetooth SIG, INC. The devices may also communicate with each other directly through an indirect path via communications network 514.

System 500 includes a digital media items database 516 which stores digital media items uploaded via user television equipment 502, user computer equipment 504, and/or wireless user communications device 506 and application source 519, to provide applications that can provide access to digital media items database 516. Digital media items database 516 and application source 519 are coupled to communications network 514 via communication paths 520 and 522, respectively. Paths 520 and 522 may include any of the communication paths described above in connection with paths 508, 510, and 512. Communications with the digital media items database 516, and application source 519 may be exchanged over one or more communications paths but are shown as a single path in FIG. 5 to avoid overcomplicating the drawing. In addition, there may be more than one of digital media items database 516 but only one of each is shown in FIG. 5 to avoid overcomplicating the drawing. Although communications between digital media items database 516 and application source 519 with devices 502, 504, and 506 are shown as through communications network 514, in some embodiments, sources 516 and 519 may communicate directly with devices 502, 504, and 506 via communication paths (not shown) such as those described above in connection with paths 508, 510, and 512.

Applications may be, for example, stand-alone applications implemented on devices, which can be downloaded from application source 519. For example, the application may be implemented as software or a set of executable instructions which may be stored in storage 408 and executed by control circuitry 404 of each one of device 400 and user equipment system 401. In some embodiments, applications may be client/server applications where only a client application resides on the device, and server application resides on a remote server. For example, an application may be implemented partially as a client application on control circuitry 404 of each one of devices 400 and user equipment systems 401 and partially on a remote server as a server application (e.g., digital media items database 516) running on control circuitry of the remote server. When executed by control circuitry of the remote server (such as digital media items database 516), the application may instruct the control circuitry to generate the content displays and transmit the generated displays to the devices. The server application may instruct the control circuitry of the digital media items database 516 to transmit data for storage on the device. The client application may instruct control circuitry of the receiving user equipment to generate the content displays.

Content and/or content data delivered to devices 502, 504, and 506 may be over-the-top (OTT) content. OTT content delivery allows Internet-enabled user devices, including any device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide content data described above.

Content output system 500 is intended to illustrate a number of approaches, or network configurations, by which devices and sources of content and content data may communicate with each other for the purpose of sharing digital media items among a plurality of users and managing rules for accessing the digital media. The embodiments described herein may be applied in any one or a subset of these approaches, or in a system employing other approaches for downloading and displaying the content.

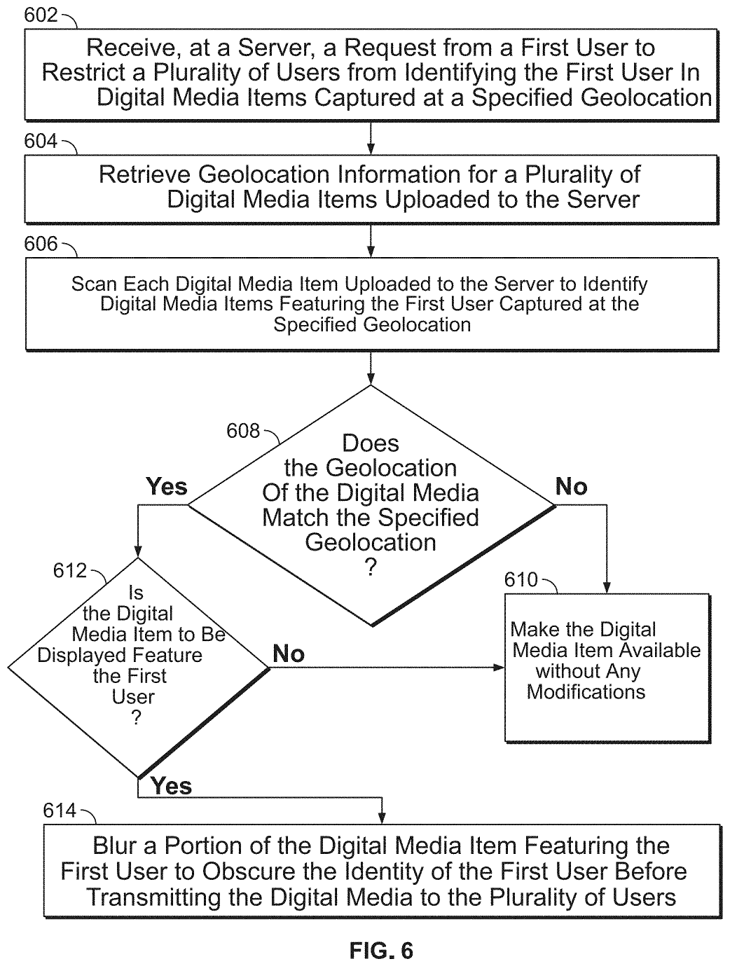

Further details of the present disclosure are discussed below in connection with the flowchart of FIG. 6. FIG. 6 depicts an illustrative flowchart of a process for restricting a plurality of users from identifying a user in digital media items captured at a specified geolocation, in accordance with some embodiments of the disclosure. The illustrative steps of process 600 may be performed by, for example, device 400 of FIG. 4, or control circuitry 404 thereof.

Step 602 includes control circuitry (e.g., control circuitry 404) receiving a request from a first user to restrict a plurality of users from identifying the first user in digital media items captured at a specified geolocation. For example, a first user Adam may request that users Tim, Maria, and Alex be restricted from viewing any images captured of him while he is at home. Step 604 includes control circuitry retrieving geolocation information for a plurality of digital media items uploaded to the server. In some embodiments, server 106 stores metadata files associated with each of the uploaded digital media items files, which include information including a time and place that the digital media items file was captured or created. For example, control circuitry 404 may retrieve geolocation information from digital media items database 516.

Step 606 includes control circuitry scanning each digital image to identify digital media items featuring the first user and captured at the specified geolocation. For example, control circuitry 404 may use any known facial recognition software to scan each digital media item uploaded to the server to identify a set of digital media items featuring the first user. Specifically, control circuitry 404 uses the results of the facial recognition software at Step 606 to identify a set of images and/or videos that feature the first user uploaded on the server.

Step 608 includes control circuitry determining whether the geolocation of the digital media items match the specified geolocation. For example, control circuitry 404 determines whether any of the images uploaded on server 106 were captured at or around Adam's home address. Control circuitry 404 may compare the geolocation information retrieved from digital media items database 516 with the specified geolocation (i.e., Adam's home address). If, at Step 608, it is determined that the geolocation of the digital media items does not match the specified geolocation (NO at Step 608), process 600 proceeds to Step 610. Step 610 includes making the digital media items available to the plurality of users without any modifications.

If, on the other hand, at step 608, it is determined that the geolocation of the digital media item does match the specified geolocation (YES at step 608), process 600 proceeds to Step 612. Step 612 includes control circuitry determining whether each of the digital media items feature the first user. For example, control circuitry 404 may use any known facial recognition software to scan each digital media item captured at the specified geolocation to identify a set of digital media items featuring the first user. Specifically, control circuitry 404 uses the results of the facial recognition software at Step 606 to identify a set of images and/or videos that feature the first user uploaded on the server and captured at the user's home.

If, at step 612, control circuitry determines that the digital media items feature the first user (YES at step 612), the process 600 proceeds to step 614 discussed below. If, on the other hand, at step 612, control circuitry determines that the digital media item does not feature the first user (NO at step 612), process 600 proceeds to step 610. Step 610 includes control circuitry making the digital media items available without any modification for viewing by the plurality of users.

Step 614 includes control circuitry modifying the digital media items to obscure the identity of the first user. For example, control circuitry 404 may blur a portion of the digital media items featuring the first user to obscure the identity of the first user before transmitting the digital media items to the social media application where they can be accessed by the plurality of users. In another embodiment, control circuitry 404 may crop the portion of the digital media items featuring the first user before transmitting the digital media items to the social media application where they can be accessed by the plurality of users. In this way, process 600 prevents the plurality of users from viewing digital media items featuring the first user while the first user is at the specified geolocation.

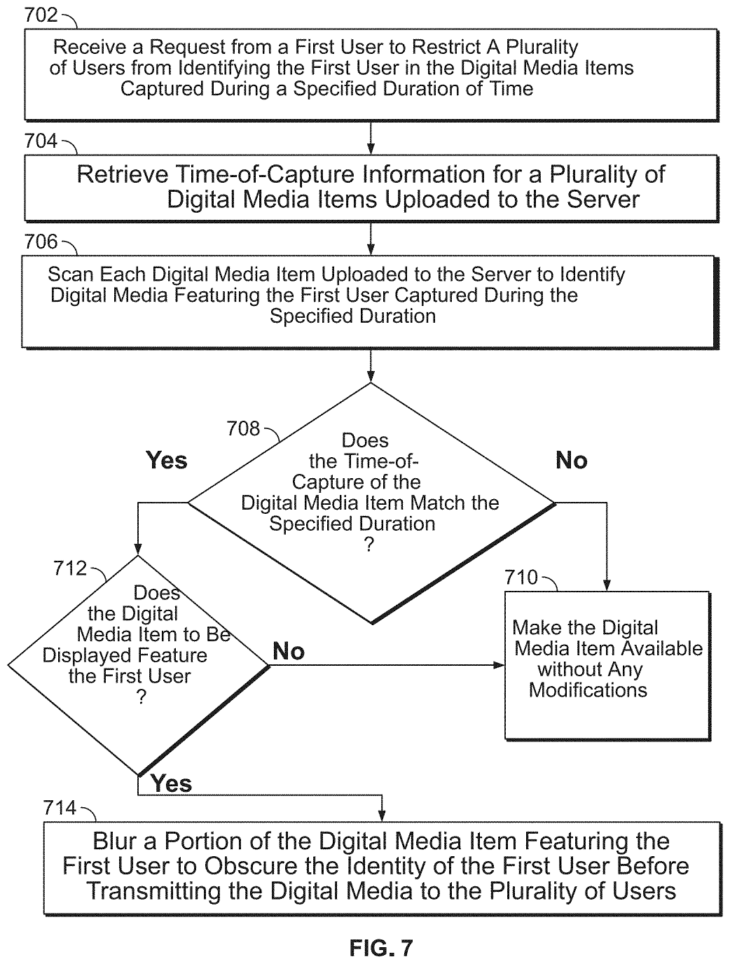

Further details of the present disclosure are discussed below in connection with the flowchart of FIG. 7. FIG. 7 depicts an illustrative flowchart of a process for restricting a plurality of users from identifying a user in digital media items captured during a specified duration, in accordance with some embodiments of the disclosure. The illustrative steps of process 700 may be performed by, for example, device 400 of FIG. 4, or control circuitry 404 thereof.

Step 702 includes control circuitry (e.g., control circuitry 404) receiving a request from a first user to restrict a plurality of users from identifying the first user in digital media items captured during a specified duration of time. For example, a first user Adam may request that his colleagues Tim, Maria, and Alex be restricted from viewing any images captured of him while he is on vacation with his family. Step 704 includes control circuitry retrieving geolocation information for a plurality of digital media items uploaded to the server. In some embodiments, server 106 stores metadata files associated with each of the uploaded digital media items files that include information including a time and place that the digital media items file was captured or created. For example, control circuitry 404 may retrieve time-of-capture information from digital media items database 516.

Step 706 includes control circuitry scanning each digital image to identify digital media items featuring the first user and captured during the specified duration of time. For example, control circuitry 404 may use any known facial recognition software to scan each digital media item uploaded to the server to identify a set of digital media items featuring the first user. Specifically, control circuitry 404 uses the results of the facial recognition software at Step 606 to identify a set of images and/or videos that feature the first user and were captured during the specified duration.

Step 708 includes control circuitry determining whether the time-of-capture of the digital media items match the specified duration. For example, control circuitry 404 determines whether any of the images uploaded on server 106 were captured while Adam was on vacation. Control circuitry 404 may compare the time-of-capture information retrieved from digital media items database 516 with the specified duration (i.e., Adam's vacation). If, at step 708, it is determined that the time-of-capture of the digital media items does not match the specified duration (NO at step 708), process 700 proceeds to step 710. Step 710 includes making the digital media items available to the plurality of users without any modifications.

If, on the other hand, at step 708, it is determined that the time-of-capture of the digital media items does match the specified duration (YES at step 708), process 700 proceeds to step 712. Step 712 includes control circuitry determining whether each of the digital media items feature the first user. For example, control circuitry 404 may use any known facial recognition software to scan each digital media item captured at the specified geolocation to identify a set of digital media items featuring the first user. Specifically, control circuitry 404 uses the results of the facial recognition software at Step 706 to identify a set of images and/or videos that feature the first user uploaded on the server and captured during the specified duration.

If, at Step 712, control circuitry determines that the digital media items feature the first user (YES at step 712), the process 700 proceeds to step 714 discussed below. If, on the other hand, at step 712, control circuitry determines that the digital media items do not feature the first user (NO at step 712), process 700 proceeds to step 710. Step 710 includes control circuitry making the digital media items available without any modification for viewing by the plurality of users.

Step 714 includes control circuitry modifying the digital media items to obscure the identity of the first user. For example, control circuitry 404 may blur a portion of the digital media items featuring the first user to obscure the identity of the first user before transmitting the digital media items to the social media application where they can be accessed by the plurality of users. In another embodiment, control circuitry 404 may crop the portion of the digital media items featuring the first user before transmitting the digital media items to the social media application where they can be accessed by the plurality of users. In this way, process 700 prevents the plurality of users from viewing digital media items featuring the first user during the specified duration of time.

The above-described embodiments of the present disclosure are presented for purposes of illustration and not of limitation, and the present disclosure is limited only the claims that follow. Furthermore, it should be noted that the features and limitations described in any one embodiment may be applied to any other embodiment herein, and flowcharts or examples relating to one embodiment may be combines with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

What is claimed is:

1. A method for controlling access to digital media, the method comprising:
receiving, at a server, a request from a first user to restrict a plurality of users from identifying the first user in the digital media, wherein the plurality of users have access to digital media items uploaded to the server;
in response to receiving the request, scanning a plurality of digital media items uploaded to the server to identify a set of digital media items related to the first user; and
restricting the plurality of users from identifying the first user in the identified set of digital media items related to the first user.

2. The method according to claim 1, wherein the plurality of digital media items is uploaded to the server via a social media application implemented on a respective client device associated with each of the plurality of users.

3. The method according to claim 1, wherein restricting the plurality of users from identifying the first user in the identified set of digital media items featuring the first user comprises:
blurring a portion of the digital media items to obscure the identity of the first user; and
presenting the blurred digital media items to the plurality of users.

4. The method according to claim 1, wherein identifying the set of digital media items related to the first user comprises:
using facial recognition to identify the first user.

5. The method according to claim 1, further comprising:
receiving, at the server, a request from the first user to restrict a plurality of users from identifying the first user in the digital media items captured at a specified geolocation;
in response to receiving the request, scanning the plurality of digital media items uploaded to the server to identify a subset of digital media items captured at the specified geolocation; and
restricting the plurality of users from identifying the first user in the identified set of digital media items captured at the specified geolocation.

6. The method according to claim 1, further comprising:
receiving, at the server, a request from the first user to restrict a plurality of users from identifying the first user in the digital media items captured during a specified duration of time;
in response to receiving the request, scanning the plurality of digital media items uploaded to the server to identify a subset of digital media items captured during the specified duration of time; and
restricting the plurality of users from identifying the first user in the identified set of digital media items captured during the specified duration of time.

7. The method according to claim 1, wherein restricting the plurality of users from identifying the first user in the identified set of digital media items featuring the first user comprises:
cropping a portion of the digital media items to remove the portion of the digital media items featuring the first user; and
presenting the cropped digital media items to the plurality of users.

8. A method for controlling access to digital media, the method comprising:
causing, using a server, a social media application to be implemented on a client device, the social media application configured to:
receive a request from a first user to restrict a plurality of users from identifying the first in the digital media;
transmit a request to the server to scan a plurality of digital media items uploaded to the server to identify a set of digital media items featuring the first user; and
receive, from the server, a set of identified digital media items related to the first user; and
transmit a request to the server to modify a portion of the identified set of digital media items to obscure the identity of the first user prior to transmitting the identified set of digital media items to a plurality of client devices having the social media application installed thereon.

9. The method according to claim 8, wherein the plurality of digital media items is uploaded to the server via a social media application implemented on a respective client device associated with each of the plurality of users.

10. The method according to claim 8, wherein the server, when identifying the set of digital media items related to the first user, is configured to:
use facial recognition software to identify the first user while scanning the plurality of digital media items uploaded to the server.

11. The method according to claim 8, wherein the server is further configured to cause the social media application to:
receive a request from the first user to restrict a plurality of users from identifying the first user in the digital media items captured at a specified geolocation;
transmit a request to the server to scan the plurality of digital media items uploaded to the server to identify a subset of digital media items captured at the specified geolocation; and
transmit a request to the server to restrict the plurality of users from identifying the first user in the identified set of digital media items captured at the specified geolocation.

12. The method according to claim 8, wherein the server is further configured to cause the social media application to:
receive a request from the first user to restrict a plurality of users from identifying the first user in the digital media items captured during a specified duration of time;
transmit a request to the server to scan the plurality of digital media items uploaded to the server to identify a subset of digital media items captured during the specified duration of time; and
transmit a request to the server to restrict the plurality of users from identifying the first user in the identified set of digital media items captured during the specified duration of time.

13. The method according to claim 8, wherein the server is further configured to cause the social media application to:
transmit a request to the server to blur a portion of the identified set of digital media items to obscure the identity of the first user prior to transmitting the identified set of digital media items to a plurality of client devices implementing having the social media application installed thereon; or
transmit a request to the server to crop a portion of the identified set of digital media items to obscure the identity of the first user prior to transmitting the identified set of digital media items to a plurality of client devices having the social media application installed thereon.

14. A system comprising:
memory storing digital media; and
control circuitry coupled to the memory and configured to:
receive a request from a first user to restrict a plurality of users from identifying the first user in the digital media, wherein the plurality of users have access to digital media items stored in the memory;
in response to receiving the request, scan a plurality of digital media items stored in the memory to identify a set of digital media items related to the first user; and
restricting the plurality of users from identifying the first user in the identified set of digital media items related to the first user.

15. The system according to claim 14, wherein the plurality of digital media items is stored in the memory via a social media application implemented on a respective client device associated with each of the plurality of users.

16. The system according to claim 14, wherein the control circuitry, when restricting the plurality of users from identifying the first user in the identified set of digital media items featuring the first user, is configured to:
blur a portion of the digital media items to obscure the identity of the first user; and
present the blurred digital media items to the plurality of users.

17. The system according to claim 14, wherein the control circuitry, when identifying the set of digital media items related to the first user, is further configured to:
use facial recognition to identify the first user.

18. The system according to claim 14, wherein the control circuitry is further configured to:
receive a request from the first user to restrict a plurality of users from identifying the first user in the digital media items captured at a specified geolocation;
in response to receiving the request, scan the plurality of digital media items uploaded to the server to identify a subset of digital media items captured at the specified geolocation; and
restrict the plurality of users from identifying the first user in the identified set of digital media items captured at the specified geolocation.

19. The system according to claim 14, wherein the control circuitry is further configured to:
receive a request from the first user to restrict a plurality of users from identifying the first user in the digital media items captured during a specified duration of time;
in response to receiving the request, scan the plurality of digital media items uploaded to the server to identify a subset of digital media items captured during the specified duration of time; and
restrict the plurality of users from identifying the first user in the identified set of digital media items captured during the specified duration of time.

20. The system according to claim 14, wherein the control circuitry, when restricting the plurality of users from identifying the first user in the identified set of digital media items featuring the first user, is configured to:
crop a portion of the digital media items to remove the portion of the digital media items featuring the first user; and
present the cropped digital media items to the plurality of users.
